(19) United States
(12) Patent Application Publication
(10) Pub. No.: US 2025/0286461 A1
(43) Pub. Date: Sep. 11, 2025

(54) MULTIPHASE POWER SUPPLY WITH EASY CONTROL

(71) Applicant: Chengdu Monolithic Power Systems Co., Ltd., Chengdu (CN)

(72) Inventors: Jian Zhang, Chengdu (CN); Wei Mao, Chengdu (CN); Ganggang Niu, Chengdu (CN)

(21) Appl. No.: 19/071,082

(22) Filed: Mar. 5, 2025

(30) Foreign Application Priority Data
Mar. 6, 2024 (CN) 202410252977.6

(51) Int. Cl. H02M 3/158; H02M 1/32; H02M 3/00

(52) U.S. Cl. CPC H02M 3/1586; H02M 1/325; H02M 3/01

(57) ABSTRACT

A multiphase power supply with easy control is discussed. The multiphase power supply has a master circuit and n slave circuits coupled in parallel with each other between in input voltage and an output voltage. The master circuit provides a first clock signal to the slave circuits via a firs synchronous port, and a second clock signal via a synchronous port. All the circuits are then configured to generate a respectively phase clock signal to control the power stage.

### CROSS-REFERENCE TO RELATED APPLICATIONS

This application claims priority to and the benefit of Chinese Patent Application No. 202410252977.6, filed Mar. 6, 2024, which is incorporated herein by reference in its entirety.

### BACKGROUND OF THE INVENTION

In power conversion field, multi-phase power supplies with phase shifting control are widely used in high power and high current applications due to high current capability with low current ripple, excellent thermal performance and power distribution. The so-called multiphase power supply refers to a circuit structure that has several power converters coupled in parallel, to provide an output to a load. Each of the power converters respectively has a controller. All of the controllers are coupled to each as a daisy chain. For example, in a three-phase power supply, the first controller has an output terminal coupled to an input terminal of the second controller, the second controller has an output terminal coupled to an input terminal of the third controller, and the third controller has an output terminal coupled to an input terminal of the first controller.

However, if a fault happens at one of the controllers, the system cannot detect which one has fault, which affects the operation of the system.

### SUMMARY OF THE INVENTION

In accordance with an embodiment of the present invention, a multiphase power supply is discussed. The multiphase power supply comprises a master circuit and n slave circuits coupled in parallel with each other. N is an integer larger than zero. The master circuit and all of the slave circuits each comprises: a first synchronous port, a second synchronous port, a control stage, and a power stage. The master circuit is configured to provide 1) a first clock signal via the first synchronous port, and a second clock signal via the second synchronous port. Each of the slave circuits is configured to receive 1) the first clock signal via the first synchronous port, and 2) the second clock signal via the second synchronous port.

In addition, in accordance with an embodiment of the present invention, a multiphase power supply is discussed. The multiphase power supply comprises: a circuit having: a first synchronous port, a second synchronous port, power stage, and a control stage. The first synchronous port is configured to receive an external clock signal, and the second synchronous port is selectively configured to output a synchronized clock signal. The power stage is configured to receive an input voltage. The control stage is configured to control the power stage based on the external clock signal.

Furthermore, in accordance with an embodiment of the present invention, a method used in a multiphase power supply is discussed. The multiphase power supply comprises a master circuit and n slave circuits coupled in parallel with each other, and n is an integer larger than zero. The method comprising: generating a first clock signal and a second clock signal at the master circuit, and receiving the first clock signal and the second clock signal at each of the slave circuits; and initiating a master phase clock signal in response to a first rising edge of the first clock signal, to control a power stage at the master circuit; and initiating n slave phase clock signals in response to different rising edges of the second clock signal, to control a corresponding power stage at each of the slave circuits; wherein the master phase clock signal and all of the n slave phase clock signals are first reset in response to the first rising edge of the first clock signal before being initiated.

### BRIEF DESCRIPTION OF DRAWINGS

FIG. 1 schematically shows a multiphase power supply 100 in accordance with an embodiment of the present invention.

FIG. 2 schematically shows timing waveforms of the first clock signal clk1, the second clock signal clk2, the master clock signal CLK_M, and all of the slave clock signals (CLK_S1, CLK_S2, . . . , and CLK_Sn).

FIG. 3 schematically shows a multiphase power supply 300 in accordance with an embodiment of the present invention.

FIG. 4 schematically shows a multiphase power supply 400 in accordance with an embodiment of the present invention.

FIG. 5 schematically shows a multiphase power supply 500 in accordance with an embodiment of the present invention.

FIG. 6 schematically shows a flowchart 600 of a method used in a multiphase power supply in accordance with an embodiment of the present invention.

### DETAILED DESCRIPTION OF THE INVENTION

Embodiments of circuits for multiphase power supply are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

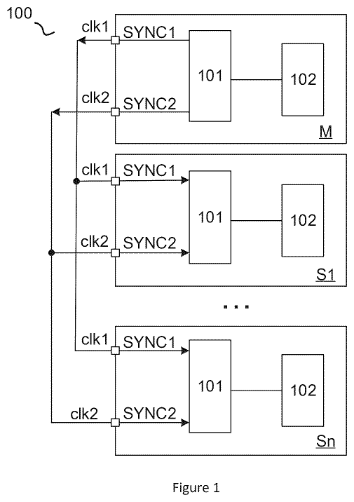

FIG. 1 schematically shows a multiphase power supply 100 in accordance with an embodiment of the present invention. In the example of FIG. 1, the multiphase power supply 100 comprises: a master circuit M and n slave circuits S1, S2, . . . , and Sn, coupled in parallel with each other between an input voltage Vᵢₙ and an output voltage Vₒ, wherein n is an integer larger than 0. The master circuit and each of the slave circuits has a first synchronous port SYNC1, a second synchronous port SYNC2, a control stage 101, and a power stage 102. The master circuit M is configured to provide 1) a first clock signal clk1 via the first synchronous port SYNC1, and 2) a second clock signal clk2 via the second synchronous port SYNC2. The second clock signal clk2 has a frequency that is (n+1) times of the first clock signal clk1. That is, assuming the frequency of the first clock signal clk1 is f1, and the frequency of the second clock signal clk2 is f2, then f2=(n+1)*f1. Each of the slave circuits is configured to receive 1) the first clock signal clk1 via the first synchronous port SYNC1, and 2) the second clock signal clk2 via the second synchronous port SYNC2. The master circuit and each of the slave circuit respectively has a phase clock signal. When a first rising edge of the first clock signal clk1 arrives, all of the phase clock signals in the master circuit and the slave circuits are reset (i.e., cleared). The master circuit M is configured to generate a master phase clock signal in response to the first rising edge of first clock signal clk1, to control an operation of the power stage in the master circuit. Each of the slave circuits is configured to generate a respective slave phase clock signal in response to a different rising edge of the second clock signal clk2, to control the operation of the corresponding power stage in respective slave circuit.

In one embodiment of the present invention, the first rising edge of the first clock signal clk1 is align to the first rising edge of the second clock signal clk2.

In one embodiment of the present invention, the system is configured to send an instruction to notice the master circuit M the total number of the slave circuit. That is, the system would tell the master circuit the specific value of the integer n.

In one embodiment of the present invention, the multiphase power supply may comprise one circuit (e.g. the master circuit). The first synchronous port in this circuit may be configured to receive an external clock signal, and the second synchronous port is selectively configured to output a synchronized clock signal or configured as a general-purpose input/output to provide a signal (e.g., a signal indicative of an inductor current)

the operation of the power stage in the circuit is controlled based on the external clock signal.

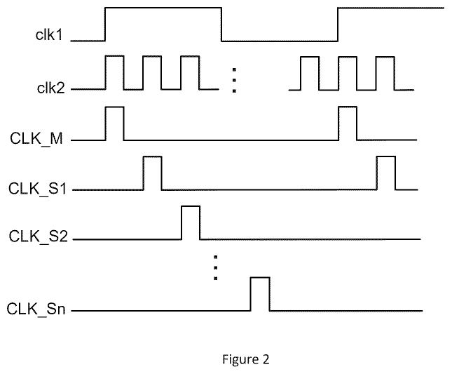

FIG. 2 schematically shows timing waveforms of the first clock signal clk1, the second clock signal clk2, the master clock signal CLK_M, and all of the slave clock signals (CLK_S1, CLK_S2, . . . , and CLK_Sn) in accordance with an embodiment of the present invention. As shown in FIG. 2, the master circuit M is configured to generate the master phase clock signal CLK_M in response to the first rising edge of the first clock signal clk1, to control the operation of the power stage in the master circuit. The first slave circuit S1 is configured to generate the first slave phase clock signal CLK_S1 in response to the second rising edge of the second clock signal clk2, to control the operation of the power stage in the first slave circuit S1. The second slave circuit S2 is configured to generate the second slave phase clock signal CLK_S2 in response to the third rising edge of the second clock signal clk2, to control the operation of the power stage in the second slave circuit S2. The nth slave circuit Sn is configured to generate the nth slave phase clock signal CLK_Sn in response to the (n+1)^{th} rising edge of the second clock signal clk2, to control the operation of the power stage in the nth slave circuit Sn.

In one embodiment of the present invention, each of the slave circuits is configured to detect a corresponding falling edge of the second clock signal clk2, and to generate a corresponding slave phase clock signal in response to the first rising edge right following the corresponding falling edge of the second clock signal clk2. Specifically, the first slave circuit S1 is configured to detect the first falling edge of the second clock signal clk2, and to generate the first slave phase clock signal in response to the first rising edge right following the first falling edge of the second clock signal clk2. The second slave circuit S2 is configured to detect the second falling edge of the second clock signal clk2, and to generate the second slave phase clock signal in response to the first rising edge right following the second falling edge of the second clock signal clk2. The nth slave circuit Sn is configured to detect the nth falling edge of the second clock signal clk2, and to generate the n^{th} slave phase clock signal in response to the first rising edge right following the nth falling edge of the second clock signal clk2.

In one embodiment of the present invention, each of the slave circuits is configured to detect the first falling edge of the second clock signal clk2 at each clock cycle of the first clock signal clk1, and to generate a corresponding slave phase clock signal in response to the corresponding rising edge of the second clock signal clk2 following the first falling edge. Specifically, the first slave circuit S1 is configured to detect the first falling edge of the second clock signal clk2, and to generate the first slave phase clock signal in response to the first rising edge following the first falling edge of the second clock signal clk2. The second slave circuit S2 is configured to detect the first falling edge of the second clock signal clk2, and to generate the second slave phase clock signal in response to the second rising edge following the first falling edge of the second clock signal clk2. The n^{th} slave circuit Sn is configured to detect the first falling edge of the second clock signal clk2, and to generate the n^{th} slave phase clock signal in response to the n^{th} rising edge following the first falling edge of the second clock signal clk2.

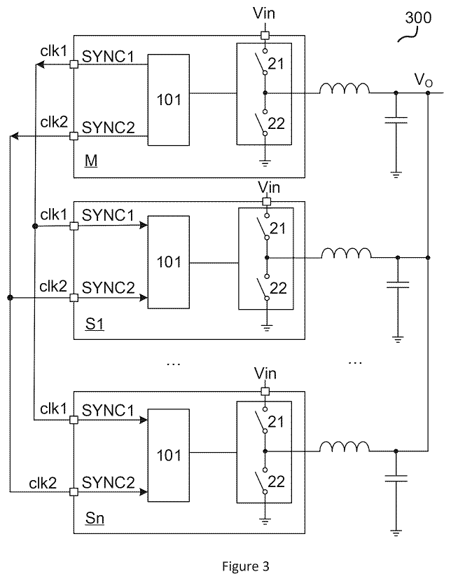

In one embodiment of the present invention, the power stages at the master circuit and each of the salve circuits may comprise a DC-DC converter. As shown in FIG. 3, a multiphase power supply 300 in accordance with an embodiment of the present invention is illustrated. In the example of FIG. 3, the power stages 102 at the master circuit and the salve circuits all comprise a buck converter, which comprises a high side power switch 21 and a low side power switch 22. Each of the power stages is configured to receive the input voltage Vin, and to provide the output voltage VO via an inductor and a capacitor.

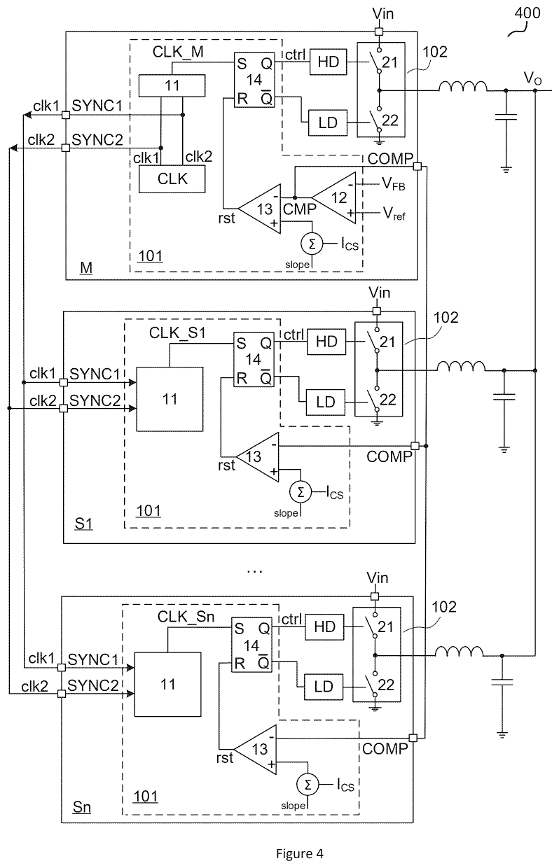

In one embodiment of the present invention, the multiphase power supply may adopt peak current mode control. FIG. 4 schematically shows a multiphase power supply 400 with a circuit configuration of the control stage 101 in accordance with an embodiment of the present invention. As shown in FIG. 4, the control stage 101 at the master circuit M comprises: a clock signal generator 110, a clock process circuit 11, an error amplify circuit 12, a comparison circuit 13, and a logical control circuit 14. The clock signal generator 110 is configured to generate the first clock signal clk1 and the second clock signal clk2. The clock process circuit 11 is configured to generate the master phase clock signal CLK_M based on the first clock signal clk1 and the second clock signal clk2. Specifically, the clock process circuit 11 is configured to generate the master phase clock signal CLK_M at the first rising edge of the second clock signal clk2. The error amplify circuit 12 is configured to amplify a difference between the reference voltage V_{ref} and a feedback voltage indicative of the output voltage Vₒ, to generate a compensation signal CMP. The comparison circuit 13 is configured to compare the compensation signal CMP with a sum of a slope signal V_{SL} and a sense signal I_{cs} indicative of a current flowing through the power stage 102, to generate a comparison signal rst. The logical control circuit 14 is configured to be set in response to the master clock signal CLK_M and to be reset in response to the comparison signal rst, to generate a control signal ctrl.

At the first slave circuit S1, the control stage 101 comprises: the clock process circuit 11, the comparison circuit 13 and the logical control circuit 14. The clock process 11 is configured to generate the first slave clock signal CLK_S1 at the second rising edge of the second clock signal clk2. The comparison circuit 13 is configured to compare the compensation signal CMP with the sum of the sense signal I_{cs} and the slope signal V_{SL}, to generate the comparison signal rst. The logical control circuit 14 is configured to be set in response to the first slave clock signal CLK_S1 and to be reset by the comparison signal rst, to generate the control signal ctrl.

The control stage at other slave circuits is similar to that at the first slave circuit S1.

In one embodiment of the present invention, the master circuit M and each of the slave circuits all have a compensation port COMP. All of the compensation ports are coupled together and are respectively coupled to an input terminal of the comparison circuit 13.

In one embodiment of the present invention, the logical control circuit 14 may comprises a RS flip flop.

During the operation of the multiphase power supply 400, at the master circuit M, the logical control circuit 14 is set in response to the rising edge of the master clock signal CLK_M. Accordingly, the high side power switch 21 in the power stage 102 is turned on, and the low side power switch 22 is turned off. The input voltage Vin is delivered to the output Vₒ. When the sense signal I_{cs} indicative of the current flowing through the high side power switch 21 reaches the compensation signal CMP, the logical control circuit 14 is reset by the comparison signal rst provided by the comparison circuit 13. Consequently, the high side power switch 21 is turned off, and the low side power switch 22 is turned on to freewheel the current. At each of the slave circuit, the high side power switch 21 is turned on and the low side power switch 22 is turned off in response to the rising edge of the corresponding slave clock signal (CLK_S1, CLK_S2, . . . , CLK_Sn). The input voltage Vin is delivered to the output Vₒ. When the sense signal I_{cs} indicative of the current flowing through the high side power switch 21 reaches the compensation signal CMP, the high side power switch 21 is turned off, and the low side power switch 22 is turned on to freewheel the current.

In one embodiment of the present invention, the first synchronous port SYNC1 at the master circuit and the slave circuits may be used to communicate for protection. As shown in FIG. 5, a multiphase power supply 500 in accordance with an embodiment of the present invention is illustrated. Specifically, in the example of FIG. 5, besides the control stage 101 and the power stage 102, the master circuit and each of the slave circuit further comprises: a fault detect circuit 103, configured to detect a fault condition (e.g., over temperature detection, over current detection, under voltage detection, over voltage detection, etc.) of the corresponding circuit; and a connect switch 104, coupled between the first synchronous port SYNC1 and the reference ground. For example, when a fault condition happens at a certain circuit (e.g., the master circuit or one of the slave circuits), the connect switch 104 is turned on, to pull low the first synchronous port SYNC1. Accordingly, the master circuit and all the salve circuits stop working.

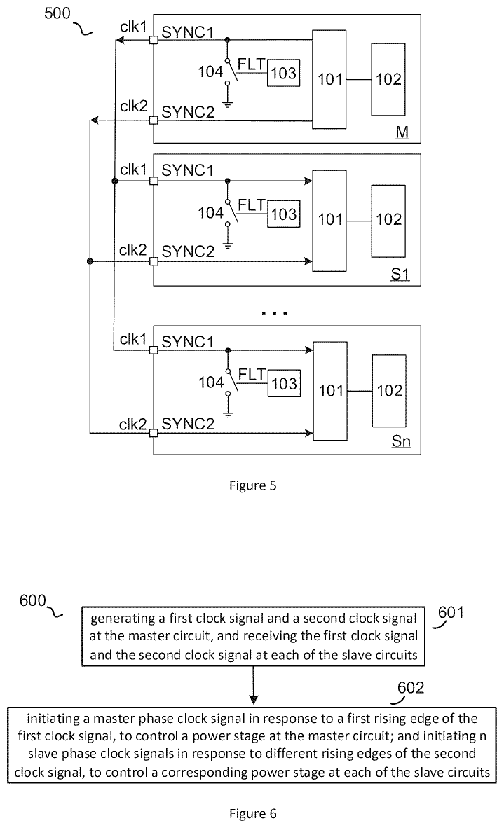

FIG. 6 schematically shows a flowchart 600 of a method used in a multiphase power supply in accordance with an embodiment of the present invention. The multiphase power supply comprises a master circuit and n slave circuits coupled in parallel with each other between an input voltage and an output voltage. N is an integer larger than 0. The method comprises:

Step 601, generating a first clock signal and a second clock signal at the master circuit, and receiving the first clock signal and the second clock signal at each of the slave circuits. The second clock signal has a frequency that is (n+1) times of the first clock signal. And

Step 602, initiating a master phase clock signal in response to a first rising edge of the first clock signal, to control a power stage at the master circuit; and initiating n slave phase clock signals in response to different rising edges of the second clock signal, to control a corresponding power stage at each of the slave circuits. The master phase clock signal and all of the n slave phase clock signals are first reset in response to the first rising edge of the first clock signal before being initiated.

In one embodiment of the present invention, the first slave circuit is configured to generate a first phase clock signal in response to a second rising edge of the second clock signal; the second phase clock signal in response to a third rising edge of the second clock signal; and the nth slave circuit is configured to generate an n^{th} phase clock signal in response to a (n+1)^{th} rising edge of the second clock signal.

Several embodiments of the foregoing multiphase power supply reset all the phase clock signals by a first clock signal. Meanwhile, each circuit is configured to generate a corresponding phase clock signal in response to a different rising edge of the second clock signal, to generate a corresponding control signal, which is used to control the power stage at each circuit. Thus, several embodiments of the foregoing multiphase power supply provide a simple control. Furthermore, when any one circuit has a fault, the fault can be quickly detected.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. A multiphase power supply, comprising:
a master circuit and n slave circuits, coupled in parallel with each other, n is an integer larger than zero; wherein the master circuit and all of the slave circuits each comprises: a first synchronous port, a second synchronous port, a control stage, and a power stage; and wherein:
the master circuit is configured to provide 1) a first clock signal via the first synchronous port, and 2) a second clock signal via the second synchronous port; and
each of the slave circuits is configured to receive 1) the first clock signal via the first synchronous port, and 2) the second clock signal via the second synchronous port.

2. The multiphase power supply of claim 1, wherein:
the second clock signal has a frequency that is (n+1) times of the first clock signal.

3. The multiphase power supply of claim 1, wherein:
the first clock signal has a first rising edge align to a first rising edge of the second clock signal.

4. The multiphase power supply of claim 1, wherein:
the master circuit and all the slave circuits each has a phase clock signal, which is configured to be reset in response to a first rising edge of the first clock signal.

5. The multiphase power supply claim 4, wherein:
the master circuit is configured to generate a master phase clock signal in response to the first rising edge of first clock signal.

6. The multiphase power supply of claim 4, wherein:
each of the slave circuits is configured to generate a corresponding slave phase clock signal in response to a different rising edge of the second clock signal.

7. The multiphase power supply of claim 4, wherein:
each of the slave circuits is configured to detect a corresponding falling edge of the second clock signal, and to generate a corresponding slave phase clock signal in response to a first rising edge right following the corresponding falling edge of the second clock signal.

8. The multiphase power supply of claim 4, wherein:
each of the slave circuits is configured to detect a first falling edge of the second clock signal, and to generate a corresponding slave phase clock signal in response to a corresponding rising edge following the first falling edge of the second clock signal.

9. The multiphase power supply of claim 1, wherein the control stage in the master circuit comprises:
a clock signal generator, configured to generate the first clock signal and the second clock signal;
and
a clock process circuit, configured to generate a master phase clock signal based on the first clock signal and the second clock signal; wherein the control stage is configured to control the power stage based on the master phase clock signal.

10. The multiphase power supply of claim 1, wherein the control stage in each of the slave circuits comprises:
a clock process circuit, configured to generate a corresponding slave phase clock signal in response to the first clock signal and the second clock signal.

11. The multiphase power supply of claim 1, the master circuit and all of the slave circuits each further comprises:
a fault detect circuit, configured to detect a fault condition; and
a connect switch, coupled between the first synchronous port and a reference ground.

12. A multiphase power supply, comprising:
a circuit, having:
a first synchronous port and a second synchronous port, wherein the first synchronous port is configured to receive an external clock signal, and the second synchronous port is selectively configured to output a synchronized clock signal;
a power stage, configured to receive an input voltage; and
a control stage, configured to control the power stage based on the external clock signal.

13. The multiphase power supply of claim 12, wherein the control stage comprises:
a clock signal generator, coupled to the first synchronous port.

14. The multiphase power supply of claim 12, wherein the circuit is a master circuit, and wherein the multiphase power supply further comprises:
n slave circuits, each of the n slave circuits is coupled in parallel with the master circuit, wherein n is an integer larger than zero, and wherein each of the slave circuits respectively comprises:
a first synchronous port, configured to receive a first clock signal provided by the master circuit;
a second synchronous port, configured to receive a second clock signal provided by the master circuit;
a control stage; and
a power stage.

15. The multiphase power supply of claim 14, wherein:
the second clock signal has a frequency that is (n+1) times of the first clock signal.

16. The multiphase power supply of claim 14, wherein:
each of the slave circuits is configured to generate a slave phase clock signal in response to a different rising edge of the second clock signal; and
each of the slave phase clock signal is configured to be reset in response to a first rising edge of the first clock signal.

17. A method used in a multiphase power supply, wherein the multiphase power supply comprises a master circuit and n slave circuits coupled in parallel with each other, n is an integer larger than zero, the method comprising:
generating a first clock signal and a second clock signal at the master circuit, and receiving the first clock signal and the second clock signal at each of the slave circuits; and
initiating a master phase clock signal in response to a first rising edge of the first clock signal, to control a power stage at the master circuit; and initiating n slave phase clock signals in response to different rising edges of the second clock signal, to control a corresponding power stage at each of the slave circuits; wherein the master phase clock signal and all of the n slave phase clock signals are first reset in response to the first rising edge of the first clock signal before being initiated.

18. The method of claim 17, further comprising:
initiating a first slave phase clock signal in response to a second rising edge of the second clock signal;
initiating a second slave phase clock signal in response to a third rising edge of the second clock signal; and
initiating an nth slave phase clock signal in response to an (n+1)^{th} rising edge of the second clock signal.

19. The method of claim 17, further comprising:
detecting a first falling edge of the second clock signal, to initiate a first slave phase clock signal in response to a first rising edge right following the first falling edge of the second clock signal;
detecting a second falling edge of the second clock signal, to initiate a second slave phase clock signal in response to the first rising edge right following the second falling edge of the second clock signal; and
detecting an nth falling edge of the second clock signal, to initiate an n^{th} slave phase clock signal in response to the first rising edge right following the n^{th} falling edge of the second clock signal.

20. The method of claim 17, wherein:
the second clock signal has a frequency that is (n+1) times of the first clock signal.
